(19) United States
(12) Patent Application Publication
(10) Pub. No.: US 2008/0140818 A1
(43) Pub. Date: Jun. 12, 2008

(54) Video Processing Apparatus and Method for Managing Operations Based on Telephony Signals

(75) Inventors: Thomas L. Du Breuil, Ivyland, PA (US); Thomas F. Kister, Chalfont, PA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/608,488

(22) Filed: Dec. 8, 2006

(51) Int. Cl. G06F 15/173

(52) U.S. Cl. 709/223

(57) ABSTRACT

A video processing device (10) and method (40) for managing operations, such as digital video recording operations, based on telephony signals, including caller ID signals. The method includes receiving multimedia content, receiving telephony signals and performing one or more video processing device operations, such as digital video recorder operations, in response to receiving the telephony signals. The video processing device includes a processor for receiving and processing multimedia content, and a memory element or storage device for storing at least a portion of received multimedia content. The processor and/or the video processing device is configured to perform one or more video processing operations in response to receiving telephony signals or instructions based on the received telephony signals. For example, the video processing device can pause the playback of multimedia content to select end user display devices in response to all or select received telephony signals, including received caller ID signals.

### BACKGROUND OF THE INVENTION

1. Field of the Invention

The invention relates to managing the operations of video processing devices, such as set-top devices, including digital video recorder (DVR) devices. More particularly, the invention relates to managing digital video recording operations and other operations of video processing devices based on telephony signals.

2. Description of the Related Art

Video processing devices, such as video converter/decoder (set-top box) devices and other digital video recorder devices, continue to provide more features and functionality to end users, including features involving more types of data content. In addition to recording and performing various end-user processes on video content and other multimedia content received from a content source for display on an end user display device, such as a television screen or computer monitor, many video processing devices are equipped and configured to receive, store and process other types of data content, including telephony information.

Caller identification, or caller ID, is a telephony service or feature that transmits a caller's name and/or telephone number to the called party's telephony device as the call is being made but before the called party answers the call. The caller ID feature usually allows the called party to identify the calling party without having to answer the call. Since caller ID is a relatively popular telephony feature, many telephony devices and other devices, including many video processing devices, include caller ID or the ability to receive caller ID as one of their features. Thus, many video processing devices can display caller ID information when a telephone call is placed to a telephony device connected to or otherwise associated with the video processing device.

It may be possible that other telephony features, such as call forwarding and various voice mail operations, including listening to voice mail, can be incorporated into video processing devices connected to or associated with the subject telephony device. Similarly, an incoming telephone call may trigger some video processing devices to automatically mute or turn down the volume of the multimedia content being displayed by an end user display device connected to the video processing device.

### BRIEF DESCRIPTION OF THE DRAWINGS

FIG. 1 is a block diagram of a video processing device for use in managing digital video recording operations based on telephony signals;

FIG. 2 is a flow chart that schematically illustrates a method for managing video processing device operations, including digital video recording operations, based on telephony signals;

FIG. 3 is a block diagram of a system arrangement including a video processing device for use in managing digital video recording operations based on telephony signals; and

FIG. 4 is a block diagram of another system arrangement including a video processing device for use in managing digital video recording operations based on telephony signals.

### DETAILED DESCRIPTION

In the following description, like reference numerals indicate like components to enhance the understanding of the video processing apparatus and method for managing digital video recording operations and other operations of video processing devices based on telephony signals through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The devices and methods described herein involve the ability of a video processing device, such as a set-top box or other digital video recorder (DVR) device, to perform various operations, including DVR operations, in response to telephony signals (including videotelephony signals) received by the video processing device or by a telephony device connected to or otherwise associated with the video processing device. For example, the video processing device can pause the playback of multimedia content to select end user display devices in response to all or select received telephony signals, including received caller ID signals. Also, the video processing device can pause the playback of multimedia content in response to an end user answering a telephone call or listening to voice mail. Depending on the length of the received telephone call, the video processing device can record the paused multimedia content and/or execute a screen saver program for the end user display device. Once the telephone call is completed, playback of the paused multimedia content can resume either automatically or at the discretion of the end user.

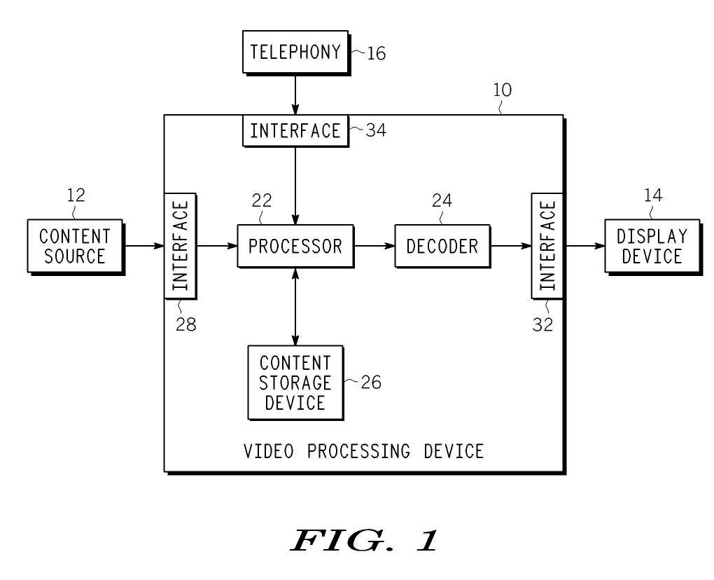

Referring now to FIG. 1, shown is a block diagram of a video processing device 10 for managing digital video recorder (DVR) operations in response to telephony signals. The video processing device 10 can be partially or completely any suitable device or subsystem (or portion thereof) for receiving multimedia content from a content source 12, processing or decoding the received multimedia content, and transmitting or transferring the processed multimedia content to an end user display device 14, such as a television, a computer monitor or other suitable display device. Although the display device 14 is shown as a separate component from the video processing device 10, it should be understood that the display device 14 and the video processing device 10 can be combined or integrated as a single component. The multimedia content can be any suitable multimedia content, including movies, programming events, music, photos and/or other multimedia content that is distributed, e.g., as one or more programming streams from a broadcast source or other suitable multimedia content source.

Suitable video processing devices include any multimedia content viewing, processing and/or storing device, such as any digital video recorder (DVR) or digital video server (DVS) device, including signal converter or decoder (set-top) boxes with internal and/or external recording capabilities and local and/or remote storage, which often are referred to as personal video recorder (PVR) devices. Other suitable video processing devices include a residential gateway, a home media server system, a digital video disk recorder, a computer, a television with built-in or added-on video content receiving and storing capability, or other suitable computing devices or video devices, including internet protocol (IP), satellite and cable digital video recorders, and home area network (HAN) devices and systems.

The content source 12 can be any suitable transmission source of multimedia content, such as over-the-air broadcasters, from a cable television plant, satellite service provider or other multimedia service provider. The content source 12 is connected to the video processing device 10 via any suitable connection, e.g., one or more coaxial cables and/or optical fibers, including a Hybrid Fiber Coaxial (HFC) cable system. Other suitable connections include suitable Fiber To The Premises (FTTP) systems, such as Fiber To The Curb (FTTC) or Fiber To The Home (FTTH), or over any suitable number of digital subscriber line systems (xDSL). Also, the multimedia content can be provided wirelessly, e.g., via over-the-air-broadcast from a satellite service provider or other suitable content service provider.

A telephony device 16 configured to receive telephony signals, including caller ID signals, can be connected to the video processing device 10. The telephony device can be one or more suitable devices and/or telephony networks that support any suitable telephony operation, including videotelephony operations. For example, the telephony device 16 can be a telephone that is part of a plain old telephone service (POTS) analog telephone service, a digital telephone service, and/or a Voice over Internet Protocol (VoIP) telephone service, and/or a mobile or cellular telephone that is part of a cellular telephone network. Alternatively, the telephony device 16 can be a telephony network that is connected to or otherwise associated with the video processing device 10, e.g., via an RJ11 jack or via an Internet network connection. The connection between the telephony device 16 and the video processing device 10 can be any suitable wired or wireless connection. Also, alternatively, the telephony device 16 can be an integrated portion of the video processing device 10, i.e., the video processing device 10 can be configured with built-in telephony capability.

The telephony device 16 can be connected to and/or associated with the video processing device 10 is any suitable manner that allows telephony signals to the telephony device and/or instructions or signals based on the telephony signals to be transmitted to the video processing device 10. For example, the telephony device 16 can be connected to the video processing device 10 directly, as shown, or via a home network, as will be discussed in greater detail herein below. Also, alternatively, the telephony device 16 can be associated with or connected to the video processing device 10 through appropriate communications between the telephony system supporting the telephony device 16 and the multimedia content provider system connected to the video processing device 10, as will be discussed in greater detail herein below. Also, as discussed herein above, the telephony device 16 can be an integrated portion of the video processing device 10.

The video processing device 10 includes a processor or processing unit 22, a decoder 24 coupled to the processor 22, and a content storage element or device 26 coupled to the processor 22. In general, the processor 22 processes information received by the video processing device 10. In addition to the content storage device 26, the processor 22 can include at least one type of memory or memory unit (not shown) and a storage unit or data storage unit coupled to the processor for storing processing instructions and/or information received by the video processing device 10. The decoder 24 typically decodes or decompresses the multimedia content to make it suitable for display, e.g., by the end user display device 14. Although the decoder 24 is shown coming after the processor 22 in the component arrangement of video processing device 10, it should be understood that the decoder 24 can come before the processor 22, i.e., the multimedia content can be decompressed prior to further processing by the processor 22.

The video processing device 10 also can include one or more input and/or output interfaces for receiving and/or transmitting multimedia content and other data and information. For example, the processor 22 and other components in the video processing device 10 can be coupled between a first or input interface 28, which receives multimedia content from the content source 12, and a second or output interface 32, which transfers processed multimedia content, including stored multimedia content, to the end user display device 14. The video processing device 10 also can include a telephony interface 34 for receiving telephony signals from the telephony device 16 or other appropriate telephony signal devices. It should be understood that one or more of the interfaces 28, 32, 34 can be a single input/output interface coupled to the processor 22. Also, it should be understood that one or more of the interfaces 28, 32, 34 can be an interface configured to support more than one content source, telephony device and/or display device.

One or more of the processor 22, the decoder 24, the content storage device 26 and the interfaces 28, 32, 34 can be comprised partially or completely of any suitable structure or arrangement, e.g., one or more integrated circuits. Also, it should be understood that the video processing device 10 includes other components, hardware and software (not shown) that are used for the operation of other features and functions of the video processing device 10 not specifically described herein.

The video processing device 10 can be partially or completely configured in the form of hardware circuitry and/or other hardware components within a larger device or group of components. Alternatively, the video processing device 10 can be partially or completely configured in the form of software, e.g., as processing instructions and/or one or more sets of logic or computer code. In such configuration, the logic or processing instructions typically are stored in a data storage device, e.g., the content storage device 26 or other suitable data storage device (not shown). The data storage device typically is coupled to a processor or controller, e.g., the processor 22, or other suitable processor or controller (not shown). The processor accesses the necessary instructions from the data storage device and executes the instructions or transfers the instructions to the appropriate location within the video processing device 10.

With respect to the content storage device 26, video processing devices typically include or have access to a hard drive or other storage element for recording streams of multimedia content, such as video streams broadcast from the multimedia content source 12. However, the content storage device 26 can be any suitable information storage unit, such as any suitable magnetic storage or optical storage device, including magnetic disk drives, magnetic disks, optical drives, optical disks, and memory devices, including random access memory (RAM) devices, and flash memory. Also, although the content storage device 26 is shown within the video processing device 10, the content storage device 26 can be located external to the video processing device 10 and suitably coupled thereto.

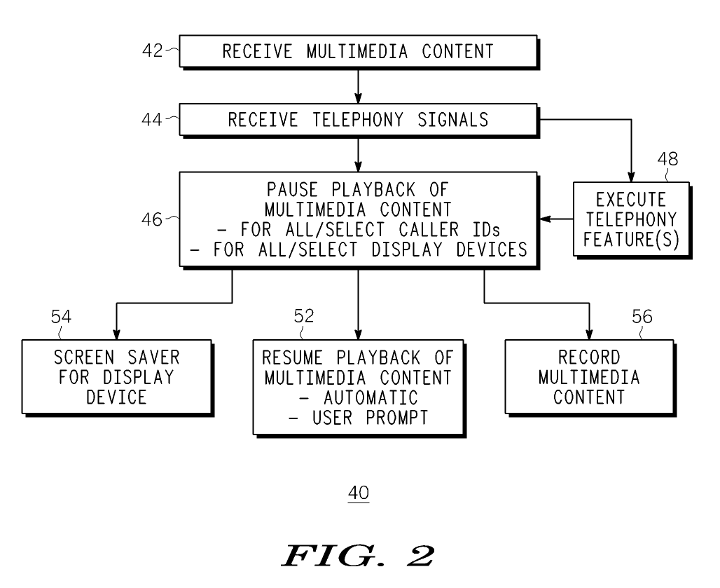

Referring now to FIG. 2, with continuing reference to FIG. 1, shown is a flow chart that schematically illustrates a method 40 for managing video processing device operations, including digital video recording operations, based on telephony signals. The method 40 includes a step 42 of receiving multimedia content, e.g., by the video processing device 10. The multimedia content, which typically is transmitted from an appropriate content source, e.g., the content source 12, typically is received by the video processing device 10 by the input interface 28 and transferred to the processor 22.

As discussed generally hereinabove, multimedia content received by the video processing device 10 can be any suitable multimedia, audio and/or video content, including movies and programming events, from any suitable multimedia content source. The multimedia content received by the video processing device 10 typically is in the form of a multimedia video and/or audio stream comprised of a plurality of digital video and/or audio signals formatted according to a suitable standard, such as the Moving Pictures Experts Group (MPEG-2 or MPEG-4) standard, and multiplexed into a data stream that is modulated on a carrier using quadrature amplitude modulation (QAM) or other suitable modulation technique.

As discussed hereinabove, the multimedia content typically is delivered to the video processing device 10 by a digital cable system, such as a Hybrid Fiber Coaxial (HFC) cable system, or other suitable content stream delivery system, such as a satellite service provider. The multimedia content stream also can be an analog video stream, or an Internet Protocol (IP) video stream transmitted over any suitable Fiber To The Premises (FTTP) system, such as Fiber To The Curb (FTTC) or Fiber To The Home (FTTH), satellite, wireless, or over any suitable number of digital subscriber line systems (xDSL). Alternatively, the multimedia content stream can be delivered to the video processing device 10 via a computer network or other suitable network, either through a wired connection or wirelessly. To receive such multimedia content, the video processing device 10 may include one or more receiving components (not shown), such as a radio frequency (RF) tuner, a QAM demodulator, an MPEG stream demultiplexor and a conditional access decryptor or decrypting module.

The method 40 also includes a step 44 of receiving telephony signals. Telephony signals typically are electrical signals that are converted from or otherwise represent sound (i.e., voice) and other data, such as caller ID and other information. Telephone signals typically are transmitted from a telephony device of an originating party (caller) through a telephone network, where caller ID and other information and/or data can be included as part of the telephony signals.

Depending on the multimedia system and telephony system arrangements, and/or the configuration of the video processing device 10 and any telephony devices 16, the telephony signals can be received by the telephony device 16 and/or the video processing device 10, either directly or indirectly. For example, in FIG. 1, telephony signals are received by the telephony device 16, which typically is a telephone or other suitable device for receiving telephony signals. All or a portion of the telephony signals can be transmitted from the telephony device 16 directly to the video processing device 10, e.g., via the interface 34 or through other appropriate connection.

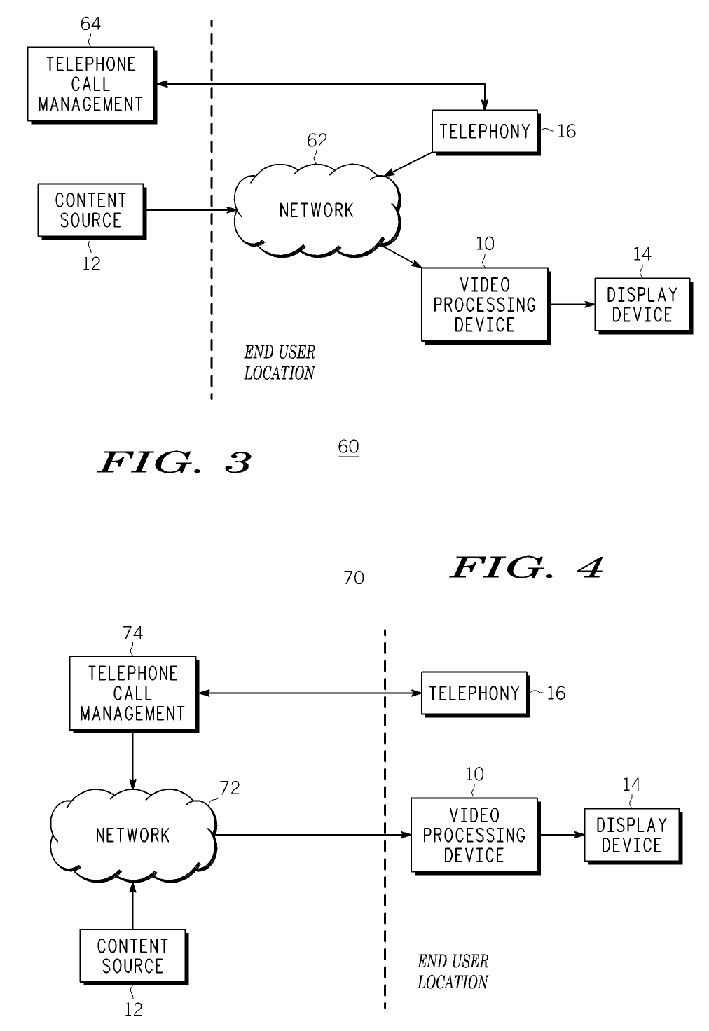

Referring now to FIG. 3, shown is a block diagram of a system arrangement 60 in which the telephony device 16 and the multimedia content source 12 are connected to the video processing device 10 through a network 62 located at the end-user location, i.e., the location of the video processing device 10. The network 62 can be any network suitable for connecting telephony devices and/or multimedia content sources to the video processing device 10. For example, the network 62 can be a home area network or a residential gateway, e.g., located in the residence of the end user who is using the video processing device 10 and the telephony device 16.

In the system arrangement 60, telephony signals are communicated between the telephony device 16 and a telephony call management service or system 64, which can be a telephone network, an exchange central office or other appropriate call management and switching system or location. Telephony signals communicated between the telephony device 16 and the telephony call management system 64 can be transmitted to the network 62. The network 62 can transmit the telephony signals (or instructions and/or commands based on the telephony signals) to the video processing device 10. It should be understood that the telephony device 16 does not have to be physically at the end user location, e.g., the telephony device 16 can be a cellular telephone. Alternatively, the telephony device 16 can be wirelessly connected to the video processing device 10 via Bluetooth™ or other suitable wireless communication protocol or technology, including one or more suitable local are network (LAN) and/or wide area network (WAN) arrangements.

Referring now to FIG. 4, shown is a block diagram of another system arrangement 70, an arrangement in which a network 72 is located external to the end-user location. In the arrangement 70, the network 72 can be a multiple services operator (MSO) or telephony service provider network, the Internet, or other suitable network that is connected between the multimedia content source 12 and a telephone call management service or system 74, such as a telephone network. Alternatively, the network 72 can be part of and/or located with either the content source 12 or the telephone call management system 74.

For example, the network 72 can be a headend, core or other network component from a cable television plant or other service provider that is configured to deliver multimedia content and telephony signals transmitted from the telephone call management system 74. Alternatively, the network 72 can be part of a telephony service provider that is configured to deliver telephony signals to and from the telephony device 16, as well as multimedia content transmitted from the content source 12. Regardless of its location, the network 72 receives telephony signals communicated between the telephony device 16 and the telephony call management system 74, as well as multimedia content from the content source 12. The network 72 transmits the telephony signals and the multimedia content to the video processing device 10, e.g., over the same connection, such as a coaxial cable connection between the network and the end-user location. Like the system arrangement 60, in the system arrangement 70, it should be understood that the telephony device 16 does not have to be physically at the end user location, e.g., the telephony device 16 can be a cellular telephone.

Referring again to FIG. 2, the method 40 includes a step 46 of performing one or more video processing device operations. According to the method 40, the video processing device 10 performs one or more video processing device operations, such as digital video recording operations, in response to the video processing device 10 receiving telephony signals, including caller ID signals, from the telephony device 16 directly or indirectly through one or more network system arrangements. Alternatively, instructions that are based on the telephony signals can be used to instruct the video processing device 10 to perform one or more video processing device operations. The instructions can be transmitted to the video processing device 10 from the telephony device 16, directly or indirectly, or from one or more network components connected between the telephony device 16 and the video processing device 10.

For example, according to the step 46, if an end user is watching a “live” time-shifted broadcast of buffered multimedia content, upon receiving telephony signals, e.g., an incoming telephone call, the video processing device 10 can pause the playback of the multimedia content in response to the incoming call. Pausing the playback of the multimedia content usually will be accompanied by the caller ID of the incoming call being displayed on the display device, although such is not necessary.

Depending on the configuration of the processor 22 and/or various end-user settings, the playback of the multimedia content may be paused only for telephony signals received by certain or selected calling parties. That is, incoming telephony signals that include caller IDs from a first set of callers may cause the video processing device 10 to pause the playback of multimedia content, while incoming telephony signals from other callers might only be displayed on the screen of the end user display device or even ignored entirely by the video processing device 10. In this manner, the end user can set or establish which incoming calls, or incoming calls from which callers, will cause the video processing device 10 to pause the playback of multimedia content and/or perform or not perform other video processing device operations.

The processor 22 and/or the video processing device 10 can be set or configured so that pausing the playback of multimedia content occurs automatically in response to incoming all or selected incoming calls. Alternatively, the processor 22 and/or the video processing device 10 can be set or configured so that pausing the playback of multimedia content in response to incoming all or selected incoming calls occurs only after the end user is first prompted and then confirms that the playback of the multimedia content should be paused. Also, alternatively, the processor 22 and/or the video processing device 10 can be set or configured so that pausing the playback of multimedia content in response to incoming all or selected incoming calls either occurs immediately or after a certain amount of time has elapsed.

In addition to being able to select or determine which incoming calls will cause the video processing device 10 to pause the playback of multimedia content, the end user can set or establish which display devices are to be affected or not affected by incoming calls. For example, if two display devices are connected to the video processing device 10, it is possible to configure the processor 22 and/or the video processing device 10 to pause the playback of multimedia content on the first display device in response to all or a select group of telephony signals, but not to pause the playback of multimedia content on the second display device. Thus, all or a select group of incoming calls may cause a display device in the end user's recreation room to pause the playback of multimedia content, while the same incoming calls (and/or other calls) may not cause a display device in the end user's bedroom to pause the playback of multimedia content.

The method 40 can include a step 48 of executing one or more telephony features or functions, which, according to the method 40, can cause the video processing device 10 to perform one or more video processing device operations. Therefore, in addition to or instead of the video processing device 10 pausing the playback of the multimedia content in response to an incoming call, the video processing device 10 can be configured or set to pause the playback of multimedia content (or perform some other video processing device operation) in response to the performance or execution of one or more other telephony features. For example, the video processing device 10 can pause the playback of multimedia content in response to an end user actually answering the telephone, instead of in response to the initial receipt of an incoming call (without answering the call). Also, for example, the video processing device 10 can be configured or set to pause the playback of multimedia content in response to an end user listening to or otherwise accessing voice mail, which typically would be connected to or otherwise controlled by the video processing device 10. It should be understood that other telephony features or functions can be performed or executed that can cause the video processing device 10 to perform one or more video processing device operations.

The method 40 can include a step 52 of resuming the playback of paused multimedia content. According to the method 40, the video processing device 10 can be configured or set to resume the playback of paused multimedia content in any number of ways. For example, playback can resume automatically after an end user hangs up the phone or otherwise completes a call. Also, playback can be set to resume after a certain amount of time has elapsed, e.g., to give the end user enough time to read caller ID information displayed on the display device, or to give the video processing device 10 or telephony device 16 enough time to transfer the incoming call to an answering machine or to voice mail. In such case, playback can be resumed regardless of whether the end user answers the call or not. Also, alternatively, the end user can be prompted when an incoming call has been completed or transferred, and playback can resume once the end user affirmatively acknowledges the prompt, e.g. via a remote control device or by other suitable means.

The method 40 can also include a step 54 of executing a screen saver program or otherwise providing a screen saver to one or more display devices, e.g., if an answered call continues for longer than a certain amount of time. For example, if the video processing device 10 has paused the playback of multimedia content in response to an incoming call, and the end user answered the incoming call, the video processing device 10 can provide a screen saver to the screen of the display device if the end user continues to be on the call beyond a certain amount of time.

The method 40 can also include a step 56 of storing or recording all or a portion of the multimedia content that has been paused in response to an incoming call or other received telephony signals. For example, if an end user answers an incoming call and the video processing device 10 pauses the playback of multimedia content, the step 56 can allow the video processing device 10 to record all or a portion of the paused program if the end user stays on the call beyond a certain amount of time. Depending on the configuration of the processor 22 and/or the video processing device 10, the multimedia content can be stored temporarily for subsequent “live” playback once the call is completed, or stored in a more permanent manner for subsequent viewing at a later time. Alternatively, if the end user stays on the call beyond a certain amount of time, the video processing device 10 can be automatically turned off altogether.

Although performing digital video recording operations in response to telephony signals primarily has been discussed hereinabove, it should be understood that, according to the method 40, other video processing device operations and related operations can be performed in response to telephony signals or instructions based on telephony signals. For example, operations related to home entertainment activities that can be performed by video processing devices and related devices, such as music and slide shows (with or without soundtracks), can be performed in response to telephony signals or instructions based on telephony signals.

Also, although video processing device operations based on or in response to telephony signals primarily has been discussed herein above, it should be understood that the operations discussed herein above also can be performed based on or in response to videotelephony signals. For example, the video processing device 10 can be connected to or have integrated therein the ability to receive videotelephony signals. In this manner, the end user can accept an incoming videotelephony call directly from the video processing device 10 and have the video processing device 10 perform one or more of the operations discussed herein above based on or in response to the received videotelephony signals.

The method shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the video processing apparatus and method for managing digital video recording operations and other operations within video processing devices based on telephony signals herein described without departing from the spirit and scope of the invention as defined by the appended claims and their full scope of equivalents.

1. A digital video recording device, comprising:
a processor configured to receive multimedia content; and
a memory element coupled to the processor for storing at least a portion of the multimedia content received by the processor;
wherein the processor is configured to perform at least one of a plurality of digital video recording operations on the received multimedia content in response to a telephony device associated with the digital video recording device receiving telephony signals including caller ID signals.

2. The device as recited in claim 1, wherein the telephony device is coupled to the digital video recording device in such a way that the digital video recording device also receives telephony signals including caller ID signals, and wherein the processor is configured to perform at least one of the plurality of digital video recording operations on the received multimedia content in response to the telephony signals received by the digital video recording device.

3. The device as recited in claim 2, wherein the telephony device is coupled to the digital video recording device via a network.

4. The device as recited in claim 1, wherein the processor is configured to pause the playback of multimedia content received by the digital video recording device in response to the received telephony signals.

5. The device as recited in claim 1, wherein the digital video recording device has a first display device coupled thereto for displaying multimedia content received by the digital video recording device and a second display device coupled thereto for displaying multimedia content received by the digital video recording device, and wherein the processor is configured to pause the playback of multimedia content displayed on the first display device in response to the received telephony signals but not to pause the playback of multimedia content displayed on the second display device in response to the received telephony signals.

6. The device as recited in claim 1, wherein the processor is configured to pause the playback of multimedia content received by the digital video recording device in response to an end user executing at least one telephony feature of the telephony device.

7. The device as recited in claim 1, wherein at least a portion of the digital video recording device is contained in a video processing device.

8. The device as recited in claim 7, wherein the video processing device is selected from the group consisting of a signal converter box, a signal decoder box, a digital video recorder, a digital video disk recorder, a personal video recorder device, a home media server, a digital video server, a residential gateway, a video receiver and a computer.

9. A method for operating a digital video recording device, the digital video recording device configured to perform at least one of a plurality of digital video recorder operations on multimedia content received by the digital video recording device, comprising the steps of:
receiving multimedia content by the digital video recording device;
receiving telephony signals by a telephony device associated with the digital video recording device, wherein the received telephony signals include caller ID signals; and
performing at least one of the plurality of digital video recorder operations on the received multimedia content in response to receiving the telephony signals by the telephony device.

10. The method as recited in claim 9, wherein the telephony device is coupled to the digital video recording device in such a way that the digital video recording device also receives the telephony signals, and wherein the digital video recording device performs at least one of the plurality of digital video recorder operations on the received multimedia content in response to the digital video recording device receiving the telephony signals.

11. The method as recited in claim 10, wherein the telephony device is coupled to the digital video recording device via a network.

12. The method as recited in claim 9, wherein the digital video recording device pauses the playback of multimedia content received by the digital video recording device in response to the received telephony signals.

13. The method as recited in claim 12, wherein the telephony signals can include a first set of caller ID signals associated with a first caller and a second set of caller ID signals associated with a second caller, and wherein the digital video recording device pauses the playback of multimedia content received by the digital video recording device in response to the first set of caller ID signals being received but not in response to the second set of caller ID signals being received.

14. The method as recited in claim 9, wherein the digital video recording device has a first display device coupled thereto for displaying multimedia content received by the digital video recording device and a second display device coupled thereto for displaying multimedia content received by the digital video recording device, and wherein the digital video recording device pauses the playback of multimedia content displayed on the first display device in response to the received telephony signals but does not pause the playback of multimedia content displayed on the second display device in response to the received telephony signals.

15. The method as recited in claim 9, wherein the digital video recording device pauses the playback of multimedia content received by the digital video recording device in response to an end user executing at least one telephony feature of the telephony device.

16. The method as recited in claim 15, wherein the digital video recording device pauses the playback of multimedia content received by the digital video recording device in response to an end user answering the telephony device.

17. The method as recited in claim 15, wherein the telephony device includes a voicemail feature, and wherein the digital video recording device pauses the playback of multimedia content received by the digital video recording device in response to an end user listening to voice mail information stored in the voice mail feature.

18. The method as recited in claim 15, wherein the digital video recording device resumes the playback of the paused multimedia content after the execution of the at least one telephony feature.

19. The method as recited in claim 15, wherein the digital video recording device prompts the end user for resuming the playback of the paused multimedia content after the execution of the at least one telephony feature.

20. The method as recited in claim 15, wherein the digital video recording device includes a memory element, and wherein the digital video recording device records at least a portion of the received multimedia content if the execution of the at least one telephony feature exceeds a first time threshold.
